(19) United States
(12) Patent Application Publication
(10) Pub. No.: US 2004/0006763 A1
(43) Pub. Date: Jan. 8, 2004

(54) Undo/redo technique with insertion point state handling for token-oriented representation of program code

(76) Inventors: Michael L. Van De Vanter, Mountain View, CA (US); Kenneth B. Urquhart, Holly Springs, NC (US)

Correspondence Address: ZAGORIN O'BRIEN & GRAHAM, L.L.P., 7600B N. CAPITAL OF TEXAS HWY., SUITE 350, AUSTIN, TX, 78731, US

(21) Appl. No.: 10/185,754

(22) Filed: Jun. 28, 2002

(51) Int. Cl. G06F 9/44

(52) U.S. Cl. 717/110

(57) ABSTRACT

An editor or other software engineering tool may be configured to represent program code as an ordered set of lexical tokens and to maintain, coincident with an operation that modifies contents of the set, an undo object that identifies a pre-modification state of an insertion point. Often, the pre-modification state includes both a token coordinates and a character coordinates representation of the insertion point and storage of pre-modification state in, or in association with, the undo object facilitates efficient implementation of a undo operation, e.g., generally without recomputation of a coordinate representation that would otherwise scale with buffer size. In this way, lexical tokens corresponding to an inserted substring can be readily and efficiently excised to restore a pre-insertion tokenized list and insertion point state. Similarly, lexical tokens corresponding to a removed substring can be readily and efficiently reinstated to restore a pre-deletion tokenized list and insertion point state.

This application is related to commonly owned U.S. patent application Nos. XX/xxx,xxx {Atty. Docket No. 004-6205, entitled “TOKEN-ORIENTED REPRESENTATION OF PROGRAM CODE WITH SUPPORT FOR TEXTUAL EDITING THEREOF,” naming Van De Vanter and Urquhart as inventors and filed on even date herewith}, XX/xxx,xxx {Atty. Docket No. 004-6206, entitled “EFFICIENT COMPUTATION OF CHARACTER OFFSETS FOR TOKEN-ORIENTED REPRESENTATION OF PROGRAM CODE,” naming Van De Vanter and Urquhart as inventors and filed on even date herewith} and XX/xxx,xxx {Atty. Docket No. 004-6207, entitled “UNDO/REDO TECHNIQUE FOR TOKEN-ORIENTED REPRESENTATION OF PROGRAM CODE,” naming Van De Vanter and Urquhart as inventors and filed on even date herewith}.

### BACKGROUND

1. Field of the Invention

The present invention relates generally to interactive software engineering tools including editors for source code such as a programming or mark-up language, and more particularly to facilities for supporting undo and/or redo operations on a token-oriented representation.

2. Description of the Related Art

In an editor for computer programs, it may be desirable to represent program code using a token-oriented representation, rather than as simply a linear sequence of characters. In such a representation, the linear sequence of characters that corresponds to program code may be divided into substrings corresponding to the lexical tokens of the particular language. In some implementations, this representation of a stream of tokens can be updated incrementally after each user action (for example, after each keystroke) using techniques such as those described in U.S. Pat. No. 5,737,608 to Van De Vanter, entitled “PER KEYSTROKE INCREMENTAL LEXING USING A CONVENTIONAL BATCH LEXER.” In general, such updates may require the insertion and/or deletion of tokens in or from the token stream.

A commonly supported and highly desirable function of conventional text editors is “Undo-Redo.” This function permits a user to reverse the effects of the most recently performed editing operation (i.e., to Undo it), and then optionally to reverse the undo in order to get back to the original state (i.e., Redo the Undo). It is generally desirable for such Undo-Redo functionality to permit a compound or multi- step Undo operation, thereby permitting the user to unwind as many of the most recently performed editing operations as desired. A compound Redo correspondingly reverses a sequence of Undo operations.

### SUMMARY

While undo-redo facilities are common in conventional text editors that employ a conventional text buffer, provision of an undo-redo facility in a software engineering tool environment that employs a token-oriented representation of program code presents unique design challenges. In general, it would desirable if undo-redo operation support could be provided for an underlying token-oriented representation in a way that ensures that such operations take no more time than other basic editing operations. In particular, it is desirable for computational requirements associated with undo-redo operations to scale such that an operation takes no more than O(N) time, where N corresponds to the size of the operation (i.e., content inserted or deleted) and where the computational requirements are generally insensitive to the size of the program being edited.

For a software engineering tool that has an insertion point representation susceptible to change as a result of undo-redo operations, scaling behavior of computations associated with insertion point update can also be important. As before, scaling should generally be insensitive to the size of the program being edited. Such scaling behavior can be particularly important in software engineering tools that track character coordinates, buffer length or other similar attributes that may be affected by an edit operation.

Accordingly, it has been discovered that an editor or other software engineering tool may be configured to represent program code as an ordered set of lexical tokens and to maintain, coincident with an operation that modifies contents of the set, an undo object that identifies a pre-modification state of an insertion point. Often, the pre-modification state includes both a token coordinates and a character coordinates representation of the insertion point and storage of pre-modification state in, or in association with, the undo object facilitates efficient implementation of a undo operation, e.g., generally without recomputation of a coordinate representation that would otherwise scale with buffer size.

In some implementations, the undo object also identifies a sublist of one or more lexical tokens corresponding to a substring that is either inserted into or removed from the list by an edit operation. In this way, lexical tokens corresponding to an inserted substring can be readily and efficiently excised to restore a pre-insertion tokenized list state. Similarly, lexical tokens corresponding to a removed substring can be readily and efficiently reinstated to restore a pre-deletion tokenized list state. Advantageously, undo support once employed to restore a prior tokenized list state is symmetrically available to support redo operations. In some embodiments in accordance with the present invention, undo-redo entries are maintained in an operation ordered set that is traversed to support one or more operations in either the undo or redo directions. In some realizations, such an ordered set of undo-redo entries is maintained by, or in conjunction with, an undo-redo manager.

By identifying a pre-modification state of an insertion point or buffer length attribute, even lengthy, complex undo (or redo) sequences can be supported with a computational overhead that scales with the number of undone (or redone) operations rather than buffer size or even size of the edits performed. As a result, a software engineering tool that employs techniques in accordance with the present invention provides extremely efficient undo-redo support even in software engineering environments that handle large bodies of program code or that provide language-oriented features such as advanced program typography or editor behavior specialized based on lexical context.

### BRIEF DESCRIPTION OF THE DRAWINGS

The present invention may be better understood, and its numerous objects, features, and advantages made apparent to those skilled in the art by referencing the accompanying drawings.

FIG. 1 depicts operation of one or more software engineering tools that operate on and/or maintain a tokenized program representation including undo/redo facilities in accordance with some embodiments of the present invention.

FIGS. 2A, 2B, 2C and 2D illustrate, in accordance with some embodiments of the present invention, states of a tokenized program representation and of related undo-redo representations in relation to operations that insert tokens into the program representation, typically in response to user edits. In particular, FIGS. 2A and 2B illustrate states before and after an edit operation that inserts tokens into the representation. FIGS. 2C and 2D illustrate states after respective undo and redo operations.

FIGS. 3A, 3B, 3C and 3D illustrate, in accordance with some embodiments of the present invention, states of a tokenized program representation and of related undo-redo representations in relation to operations that remove tokens from the program representation, typically in response to user edits. In particular, FIGS. 3A and 3B illustrate states before and after an edit operation that removes tokens from the representation. FIGS. 3C and 3D illustrate states after respective undo and redo operations.

FIG. 4 illustrates, in accordance with some embodiments of the present invention, an ordered set of undo-redo records together with a portion of a tokenized program representation after both an insertion of tokens into the representation and partial deletion of thereof.

FIGS. 5A, 5B, 5C and 5D illustrate, in accordance with some embodiments of the present invention, states of a tokenized program representation and of related undo-redo representations in relation to operations that replace a first set of one or more tokens of the program representation with a second set, typically in response to user edits. In particular, FIGS. 5A and 5B illustrate states before and after an edit operation that replaces tokens in the representation. FIGS. 5C and 5D illustrate states after respective undo and redo operations.

FIG. 6 depicts interactions between various functional components of an exemplary editor implementation that employs a token-oriented representation and for which undo-redo support may be provided in accordance with techniques of the present invention.

The use of the same reference symbols in different drawings indicates similar or identical items.

### DESCRIPTION OF THE PREFERRED EMBODIMENT(S)

Exploitations of the techniques of the present invention are many. In particular, a variety of software engineering tools are envisioned, which employ aspects of the present invention to facilitate undo-redo in a token-oriented representation of program code. One exemplary software engineering tool is a source code editor that provides specialized behavior or typography based on lexical context using a tokenized program representation. Such a source code editor provides a useful descriptive context in which to present various aspects of the present invention. Nonetheless, the invention is not limited thereto. Indeed, applications to editors, analyzers, builders, compilers, debuggers and other such software engineering tools are envisioned. In this regard, some exploitations of the present invention may provide language-oriented behaviors within suites of tools or within tools that provide functions in addition to manipulation of program code.

In addition, while traditional procedural or object-oriented programming languages provide a useful descriptive context, exploitations of the present invention are not limited thereto. Indeed, other software engineering tool environments such as those adapted for editing, analysis, manipulation, transformation, compilation, debugging or other operations on functionally descriptive information or code, such as other forms of source code, machine code, bytecode sequences, scripts, macro language directives or information encoded using markup languages such as HTML or XML, may also employ structures, methods and techniques in accordance with the present invention. Furthermore, the structures, methods and techniques of the present invention may be exploited in the manipulation or editing of other information, such as software documentation or even prose. Based on the description herein, persons of ordinary skill in the art will appreciate applications to a wide variety of tools and language contexts.

Accordingly, in view of the above and without limitation, an exemplary exploitation of the present invention is now described.

Tokenized Program Representation with Undo-Redo Support

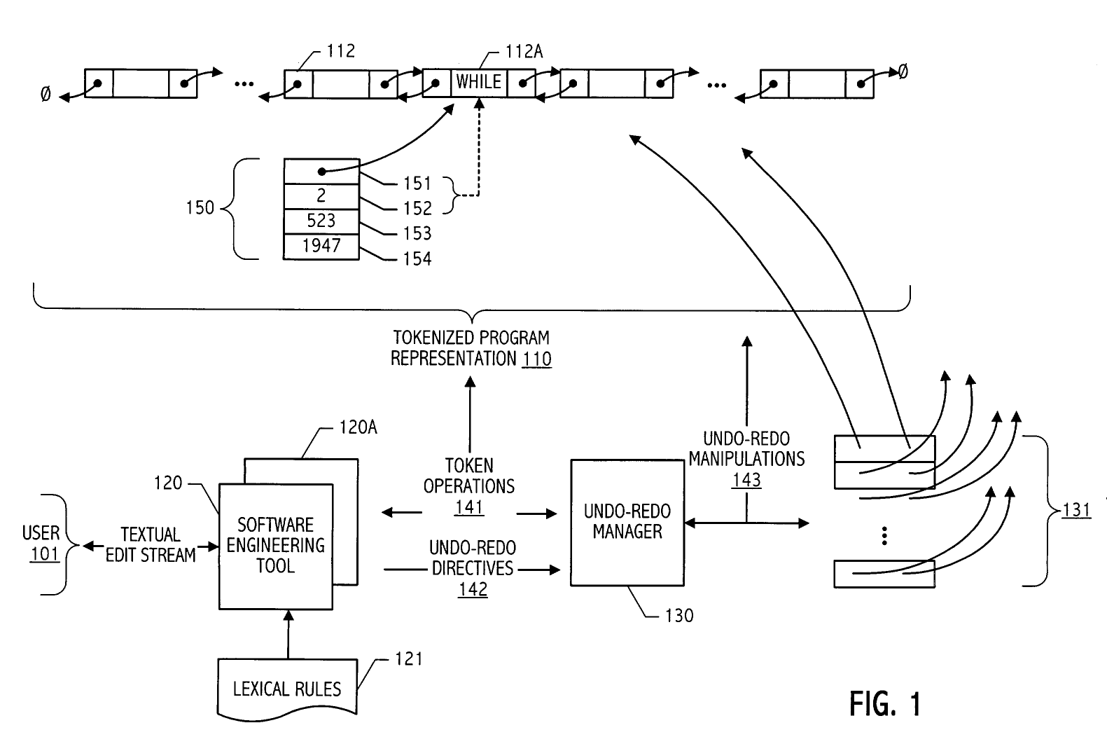

FIG. 1 depicts operation of one or more software engineering tools (e.g., software engineering tools 120 and 120A) that operate on, maintain and/or traverse a tokenized representation of information, such as tokenized program representation 110. In FIG. 1, a doubly-linked list representation of tokenized program code is illustrated. Of course, any of a variety of variable-size structures that support efficient insertion and removal may be employed. For example, although the illustration of FIG. 1 suggests plural nodes configured in a doubly-linked list arrangement with textual information associated with each such node, other information and coding arrangements are possible. In some realizations, node-associated information may be encoded by reference, i.e., by a pointer identifying the associated information, or using a token code or label. In some variations, identical textual or other information content associated with different nodes may be encoded as multiple pointers to a same representation of such information. In some realizations, information may even be encoded in the body of a node's structure itself. Whatever the particular design choice, the illustrated doubly-linked list encoding provides a flexible way of representing the tokenized program content and provides a useful illustrative context.

In the illustration of FIG. 1, an insertion point representation (e.g., insertion point 150) is used to identify a particular point in the tokenized list structure at which edit operations operate. The insertion point may be manipulated by navigation operations, as a result of at least some edit operations, or (in some configurations) based on operations of a programming tool such as a source level debugger. A variety of insertion point representations are suitable, including insertion point representations that encode text offsets. In particular, insertion point 150 illustrates one representation in which a particular token 112A that corresponds to a current insertion point in tokenized program representation 110 is identified using pointer 151. While any of a variety of conventions may be employed, one convention assumed herein for purposes of illustration is that, unless a token offset is represented (e.g., using token offset field 152), the current insertion point is just before the first character corresponding to the identified token. Other identification schemes may be employed and may fall within the scope of claim language that follows; however, for clarity of description, a simple lead token plus non-negative, character-indexed offset is used in the illustrations that follow. Accordingly, in the illustration of FIG. 1, a current insertion point between the “H” and the “I” of a character string corresponding to token 112A is identified using pointer 151 and offset field 152.

In addition to the above-described token coordinates representation, some software engineering tools benefit from a character coordinates representation. Accordingly, insertion point 150 also includes a current total character offset field 153 that identifies the current insertion point in character coordinates from a base location. Typically, and for clarity of description, we assume a base location that corresponds to a front of buffer, although other bases may be employed in some implementations. Accordingly, in the illustration of FIG. 1, a current insertion point between the “H” and the “I” of a character string corresponding to token 112A is also identified by its character offset of 523 character positions into tokenized program representation 110. For convenience, insertion point 150 also includes a buffer length field 154 that, in the illustrated configuration, represents the total length of 1947 character positions. For purposes of illustration, character offsets and total buffer lengths manipulated herein include treatment of inter-token white space (e.g., space, tab, return characters, etc.), although some implementations (including,that illustrated) may omit such white space characters from the token-oriented representation itself.

Benefits of, and support for, a character coordinates representation are described in greater detail in co-pending U.S. patent application Ser. No. XX/xxx, xxx {Atty. Docket No. 004-6206, entitled “EFFICIENT COMPUTATION OF CHARACTER OFFSETS FOR TOKEN-ORIENTED REPRESENTATION OF PROGRAM CODE,” naming Van De Vanter and Urquhart as inventors and filed on even date herewith}, which is incorporated in its entirety herein by reference. In general, character coordinates data may be encoded and maintained in association with an insertion point representation that also includes token coordinates to improve the efficiency of manipulations of the tokenized program representation. For purposes of this description, any of a variety of insertion point representations may be employed. For example, a given implementation may employ other data structures, other base-offset conventions, subsets and/or supersets of the illustrated data, etc. Therefore, without loss of generality, edit operations and other manipulations including those for undo-redo support are described herein using an illustrative insertion point representation patterned on insertion point 150. Of course, other insertion point representations may fall within the scope of claim language that follows.

As illustrated in FIG. 1, one or more software engineering tools may operate on the contents of tokenized program representation 110 using token operations 141. Illustrative token operations include insertion, removal, and/or replacement of tokens in or from tokenized program representation 110. Lexical rules 121 facilitate decomposition, analysis and/or parsing of a textual edit stream, e.g., that supplied through interactions with user 101, to transform textual operations into token oriented operations. In general, any of a variety of lexical analysis techniques may be employed. However, in some implementations, tokens are updated incrementally after each user action (for example, after each keystroke) using incremental techniques such as those described in U.S. Pat. No., 5,737,608 to Van De Vanter, entitled “PER KEYSTROKE INCREMENTAL LEXING USING A CONVENTIONAL BATCH LEXER,” the entirety of which in incorporated herein by reference. Other lexical analysis techniques may be employed in a given implementation. Whatever the techniques employed, a textual edit stream will, in general, result in updates to tokenized program representation 110 that can be defined in terms of insertions, deletion and/or replacements of one or more tokens thereof. The description that follows describes insertion, deletion and replacement operations and associated representations that facilitate efficient undo-redo handling.

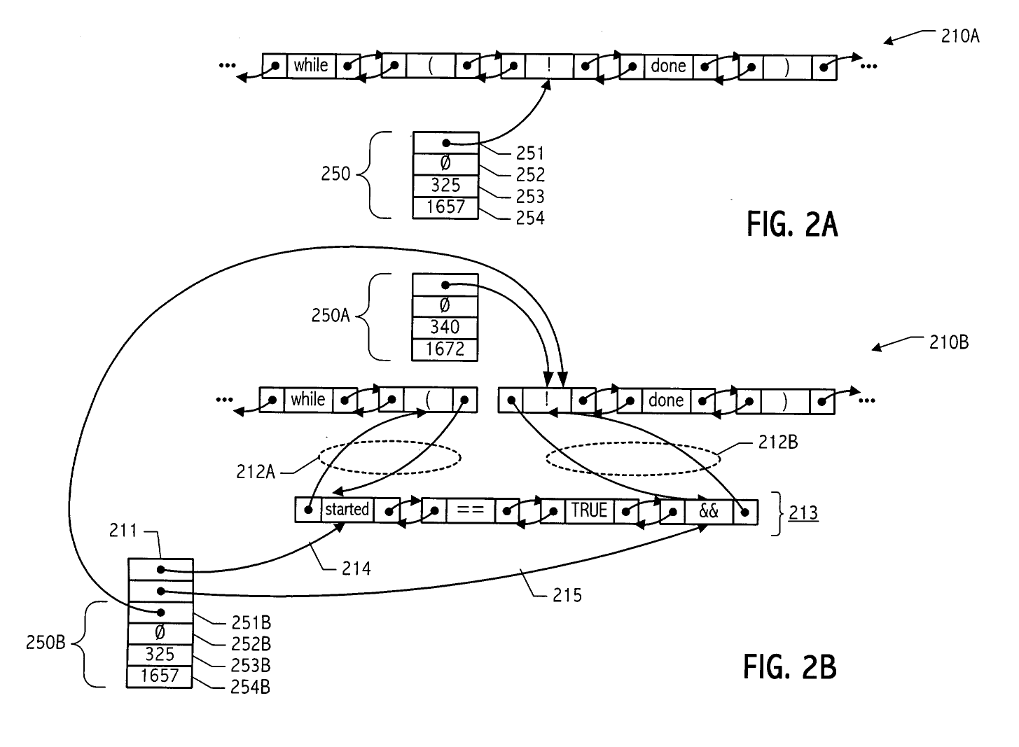

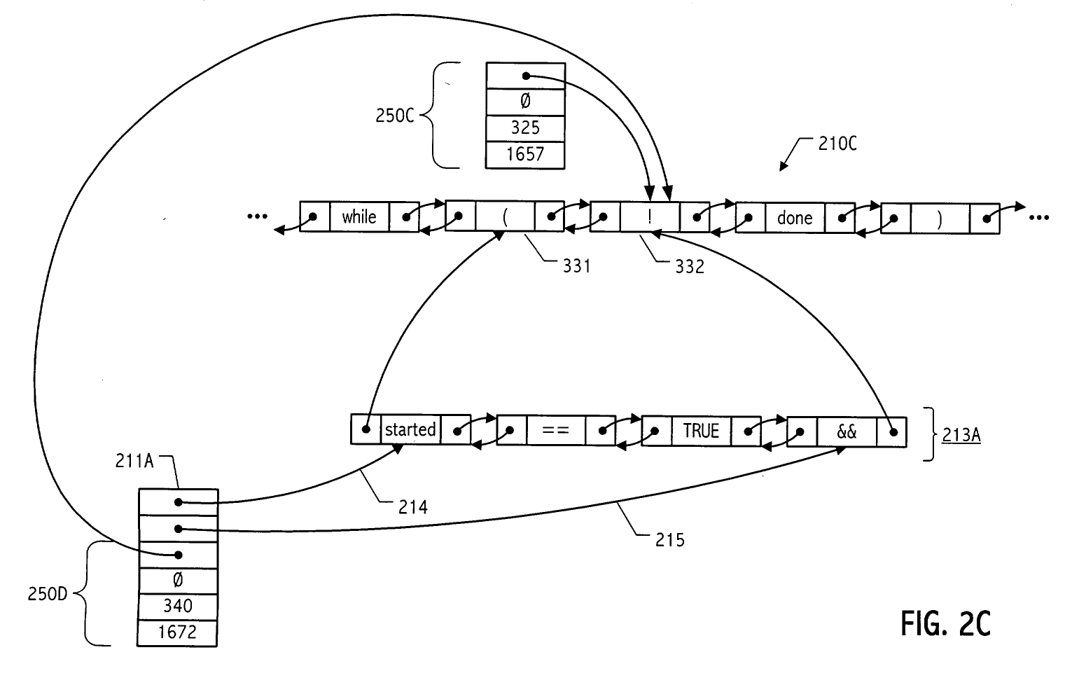

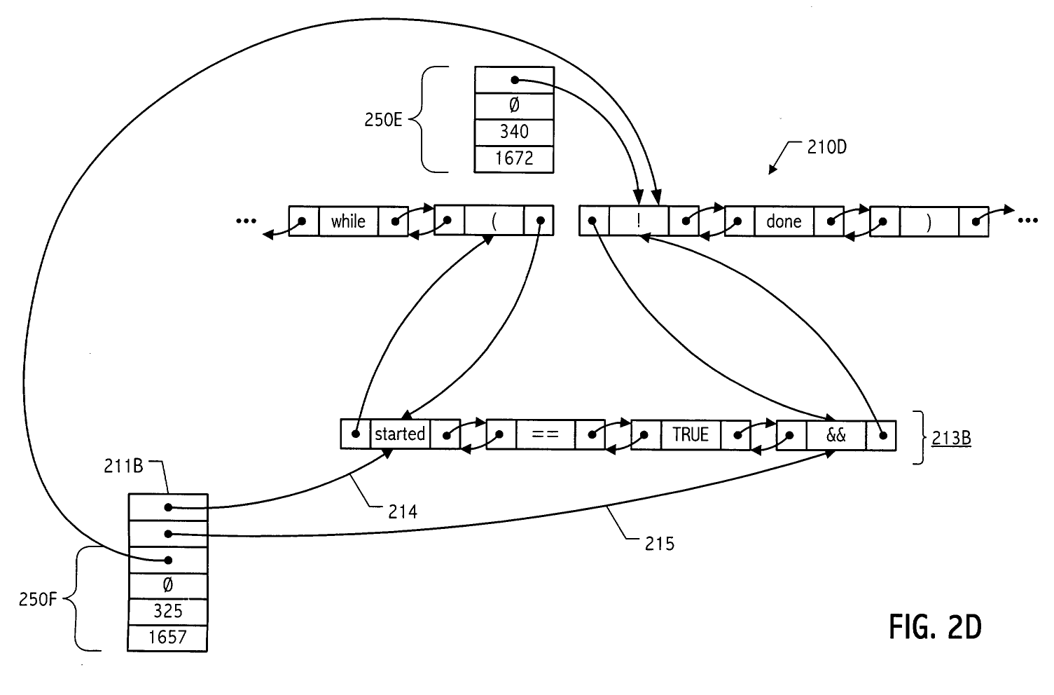

An undo-redo manager 130 maintains an ordered set 131 of undo-redo objects or structures that facilitate manipulations of tokenized program representation 110 to achieve the semantics of undo and redo operations. In general, undo-redo manager 130 is responsive to undo-redo directives 142 supplied by software engineering tool 120. Typically, undo-redo directives are themselves responsive to user manipulations, although other sources (such as from automated tools) are also possible. In the illustration of FIG. 1, individual undo-redo structures identify respective pre-modification states of an insertion point into the edit buffer to facilitate undo and redo operations as now described with reference to FIGS. 2A through 5D. Undo-redo manager implementations for editors that represent content in a text buffer are well known in the art, see e.g., Finseth, The Craft of Text Editing, Springer-Verlag (1991). Indeed, one suitable undo-redo manager framework that may be extended with objects and methods described herein is the Swing graphical user interface (GUI) component toolkit, part of the Java Foundation Classes (JFC) integrated into Java 2 platform, Standard Edition (J2SE), available from Sun Microsystems, Inc. In particular, the subclass javax.swing.undo.UndoManager (available at java.sun.com) and its related classes, objects and methods provide one exemplary implementation of a suitable undo-redo manager implementation framework.

FIGS. 2A, 2B, 2C and 2D illustrate various successive states of a tokenized program representation that is manipulated in response to an insert operation (i.e., an operation that inserts one or more tokens) and successive undo and redo operations. Beginning with FIG. 2A, we illustrate a partial state 210A of the tokenized program representation in which program code has been tokenized in accordance with lexical rules appropriate for a programming language, such as the C programming language. For simplicity of illustration, only a partial buffer state corresponding to a fragment,

. . . while (!done) . . . ,

of the total program code is illustrated and the illustrated insertion adds a token chain corresponding to an additional predicate.

Insertion point 250 identifies a current insertion point in partial state 210A using pointer 251 and a null character offset (from field 252). In particular, the FIG. 2A illustrates current insertion point just before the“!” character of the above-described fragment. In addition, insertion point 250 includes an identification of the current insertion point, in character coordinates, as 325 character positions (see offset field 253) into the tokenized program representation and a representation of total buffer length of 1657 character positions (see field 254). FIG. 2A serves as a base state from which operations to maintain the insertion point and tokenized program representation in the face of token insertion operations, as well as undos and redos thereof, will be better understood.

Turning to FIG. 2B, we illustrate the result of an insertion into the tokenized program representation (pre-insertion state 210A) of four additional tokens (fragment 213) corresponding to user edit(s) of the program code. In the illustration of FIG. 2B, updates to bi-directional pointers 212A and 212B effectuate the token insertion into the tokenized program representation resulting in post-insertion state 210B. Insertion point 250A includes an identification of the post-insertion state of the insertion point, in both token coordinates and character coordinates. Based on conventional semantics of an insertion operation, the token identification remains the same as before; however, the character coordinates representation has changed in correspondence with attributes of a string representation of inserted fragment 213. In addition, total buffer length has been similarly updated.

Of note, an undo-redo structure 211 is illustrated, which directly identifies (through respective pointers 214 and 215) opposing ends of the inserted fragment 213. In addition, undo-redo structure 211 includes a stored (or cached) insertion point representation 250B corresponding to the insertion point state and total buffer length state that existed prior to operation of the illustrated insertion. Pointer 251B, in-token character offset field 252B, character offset field 253B and total buffer length field 254B encode respective pre-insertion states. For efficiency of manipulation (and convenience of illustration), the structure of insertion point representation 250B generally corresponds to that of the current insertion point state 250A. However, implementations may employ differing representations, if desired. For example, rather than explicitly encoding data corresponding to each field of the illustrated insertion point structure, a single integer modifier may be encoded and the full state of the illustrated insertion point representation arithmetically regenerated using the integer modifier and other baseline information in the undo-redo structure. For simplicity, only the undo-redo structure associated with the illustrated insertion is shown in FIG. 2B. However, based on the description herein, persons of ordinary skill in the art will appreciate that a total representation of program code and undo- redo state may (and typically does) include additional undo-redo structures.

Turning to FIG. 2C, we illustrate results of an undo operation that reverses the effect on the tokenized program representation of the previously executed insertion operation. Note that, while the doubly-linked list state is restored, the previously inserted fragment 213A of tokens continues to be represented and identified by a corresponding undo-redo structure, namely undo-redo structure 211A. Furthermore, the previously inserted program fragment (now excised from the tokenized program representation, state 210C) maintains its identification of splice point nodes of in the tokenized program representation, namely splice point nodes 331 and 332. In this way, the states of the tokenized program representation and of the previously inserted, but undone, fragment 213A identified by undo-redo structure 211A are well situated to support redo of the previously undone insertion. To effectuate insertion point restoration, the stored (pre-insertion) insertion point representation 250B is swapped for that represented as current insertion point state 250A (recall FIG. 2B). The resulting swapped states are illustrated in FIG. 2C. For efficiency of undo operation execution, such a swap may be implemented using a swap of pointers (not specifically shown) to respective data structures. Of course, other implementations (including use of object close or simply swapping objects) may be suitable in a given realization.

Results of a redo are illustrated in FIG. 2D. Reinstatement of the token insertion into the tokenized program representation is effectuated by re-establishing the bi-directional pointer chain through previously inserted (and previously-undone) fragment 213B, resulting inpost-redo state 210D. Of note, undo-redo structure 211A state (see FIG. 2C) provides the reference chains that allow update of respective pointers of splice point nodes 331 and 332 to efficiently redo the previously undone insertion of fragment 213A. After completion of the redo operation, undo-redo structure 211B continues to identify (through respective pointers 214 and 215) opposing ends of the inserted fragment 213B. In this way, a subsequent undo may be efficiently supported. As before, to effectuate insertion point restoration, the stored (post undo or post-insertion) insertion point representation 250D is swapped for that represented as current insertion point state 250C (recall FIG. 2C). The resulting swapped states are illustrated in FIG. 2D. For efficiency of redo operation execution, swap may be implemented using a swap of pointers to respective data structures. As before, other implementations (including use of object close or simply swapping objects) may be suitable in a given realization. It is noteworthy that the states illustrated in FIGS. 2B and 2D are equivalent. As a result, it is clear that alternating undo and redo operation sequences of indefinite length may be performed while preserving desired behavior and state.

Based on the description above, persons of ordinary skill in the art will appreciate a variety suitable functional implementations to support the above-described token insertion, undo of token insertion, and redo of token insertion. The following class definitions are illustrative and used throughout the description of insertion operations (as well as remove and replace operations detailed later).

// Represents a token in a doubly linked list.
// There are sentinel tokens at each end of the list, so that
// no pointers in tokens which are proper members of the list
// are null.
class Token {

public Token next;
public Token previous;
public String text;
. . .

}
// Represents a stream of tokens, represented as a doubly linked
// list with beginning and ending sentinels. The total number of
// characters in the stream is cached at all times.
public class TokenStream {

Token bos;
Token eos;
int length;
. . .

}
// Represents a character position where editing operations may be
// performed in a doubly linked list of token nodes. The position
// is recorded in two formats:
// - a (token,offset) pair, and
// - an integer offset that represents the position in characters
// from the beginning of the stream.
class Point {

public TokenStream stream;
public Token token;
public int tokenOffset;
public int streamOffset;
. . .

}
// Interface for objects that represent the ability to undo and
// redo a single editing operation in a token stream.
interface UndoRedo {

public void undo(Point point);
public void redo(Point point);

}

The exemplary code that follows illustrates one such suitable functional implementation of the insertion operation.

// Represents a stream of tokens, represented as a doubly linked
// list with beginning and ending sentinels. The total number of
// characters in the stream is cached at all times.
public class TokenStream {

. . .
// Method for inserting tokens into a doubly linked list at
// a point between tokens.
// Precondition:
// - <point> refers to the beginning of a token in a doubly
// linked list of Tokens with sentinels, or possibly to the
// ending sentinel. <point>.tokenOffset thus must be 0.
// - <first> refers to the first of a doubly linked list of at
// least one Token, which are not in the list referred to by
// <point>
// - <last> refers to the last of these tokens
// Postcondition:
// - <point> points to the same position.
// - The tokens beginning with <first> and ending with <last>
// are in the token list, which is otherwise unchanged,
// immediately prior to the token pointed to by <point>.
// - The cached values in <point> for character
// offset and buffer length are updated.
public UndoRedo insert (Token first, Token last, Point point) {

Token lastBefore = point.token.previous;
Token firstAfter = point.token;
lastBefore.next = first;
first.previous = lastBefore;
last.next = firstAfter;
firstAfter.previous = last;
UndoRedo undoRedo = new InsertUndoRedo(first, last,

point);

int insertedLength = computeLength(first, last);
point.streamOffset += insertedLength;
length += insertedLength;
return undoRedo;

}
. . .

}

Undo and redo support may be implemented according to the following exemplary code.

class InsertUndoRedo implements UndoRedo {

private Token first;
private Token last;
private Token token;
private int tokenOffset;
private int streamOffset;
private int streamLength;
public InsertUndoRedo (Token first, Token last, Point point) {

this.first = first;
this.last = last;
this.token = point.token;
this.tokenOffset = point.tokenOffset;
this.streamOffset = point.streamOffset;
this.streamLength = point.stream.length;

}
// Exchange state with <point> and the values cached in
// this object
private void swapState(Point point) {

Token tempToken = point.token;
point.token = this.token;
this.token = tempToken;
int tempTokenOffset = point.tokenOffset;
point.tokenOffset = this.tokenOffset;
this.tokenOffset = tempTokenOffset;
int tempStreamOffset = point.streamOffset;
point.streamOffset = this.streamOffset;
this.streamOffset = tempStreamOffset;
int tempStreamLength = point.stream.length;
point.stream.length = this.streamLength;
this.streamLength = tempStreamLength;

}
// Precondition:
// - The state of the token list is just as it was when
// the tokens were originally inserted and this object
// created.
// - <point> refers to the beginning of the token before which
// the tokens were inserted.
// Postcondition:
// - <point> refers to the same position.
// - The state of token list is just as it was before
// the tokens were originally inserted; the inserted tokens
// are not in the list.
public void undo(Point point) {

Token lastBefore = first.previous;
Token firstAfter = last.next;
lastBefore.next = firstAfter;
firstAfter.previous = lastBefore;
swapState(point);

}
// Precondition:
// - The state of the token list is just as before
// the tokens were originally inserted and this object
// created; the tokens beginning with <first> and ending with
// <last> are not in the token list.
// - <point> refers to the beginning of the token before which
// the tokens were originally inserted.
// Postcondition:
// - <point> refers to the same position.
// - The tate of the token list is just as it was when the
// tokens were originally inserted and this object created;
// the inserted tokens are back in the list in their inserted
// location.
public void redo(Point point) {

Token lastBefore = first.previous;
Token firstAfter = last.next;
lastBefore.next = first;
firstAfter.previous = last;
swapState(point);

}

}

The preceding code is object-oriented and is generally suitable for use in a implementation framework such as that presented by the previously described the Swing graphical user interface (GUI) component toolkit, part of the Java Foundation Classes (JFC) integrated into Java 2 platform, Standard Edition (J2SE). However, other implementations, including procedural implementation and implementations adapted to design constraints of other environments, are also suitable.

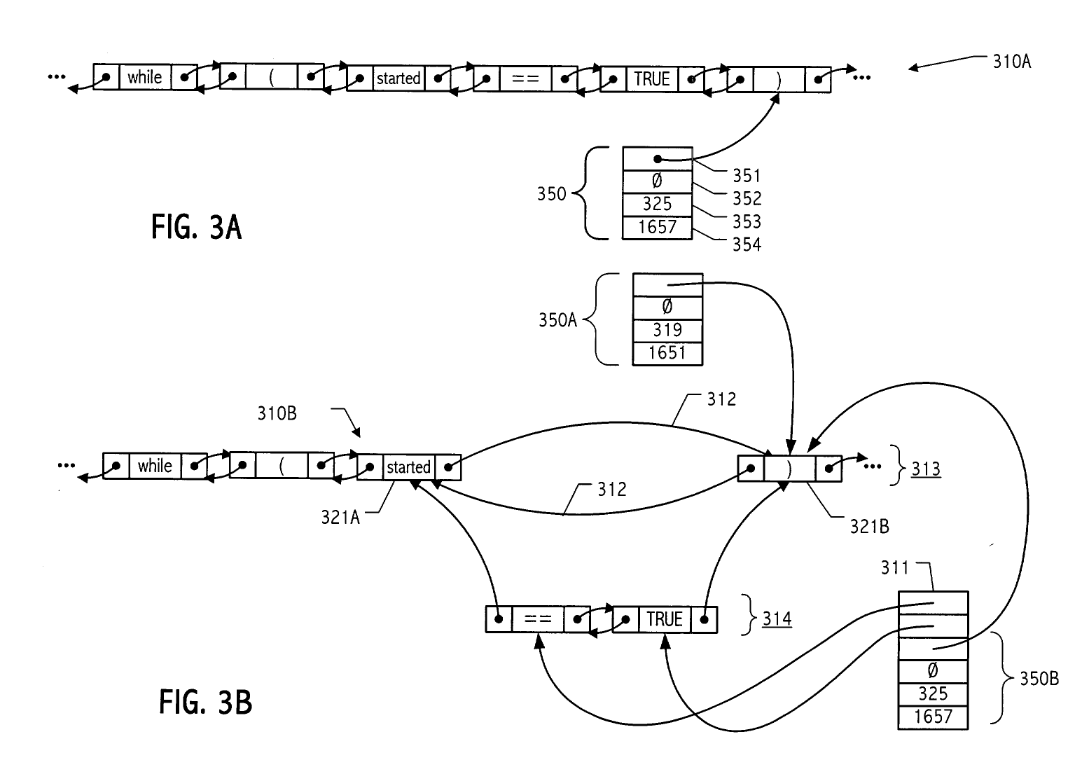

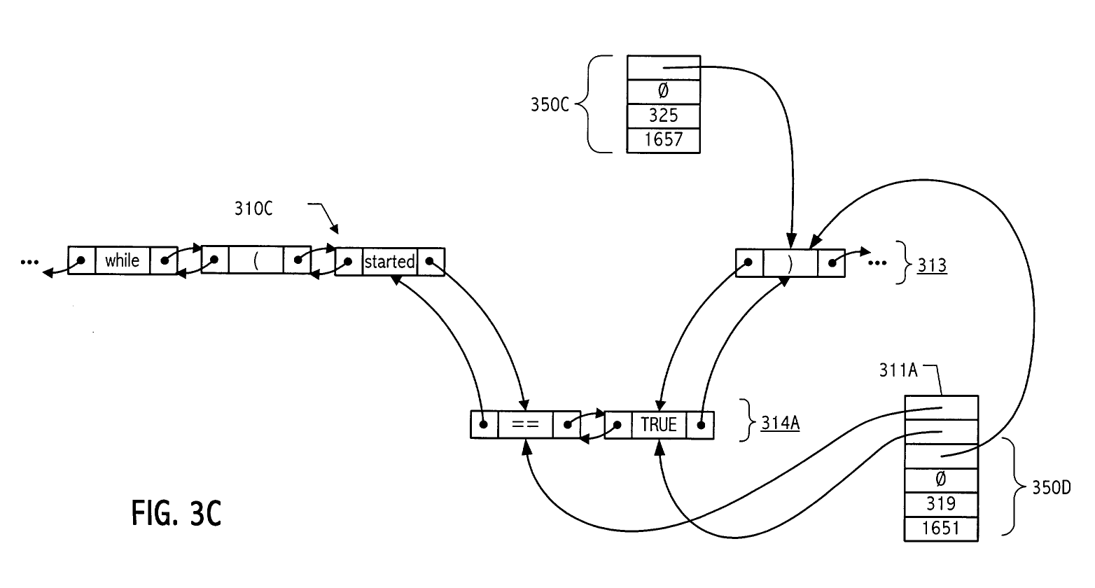

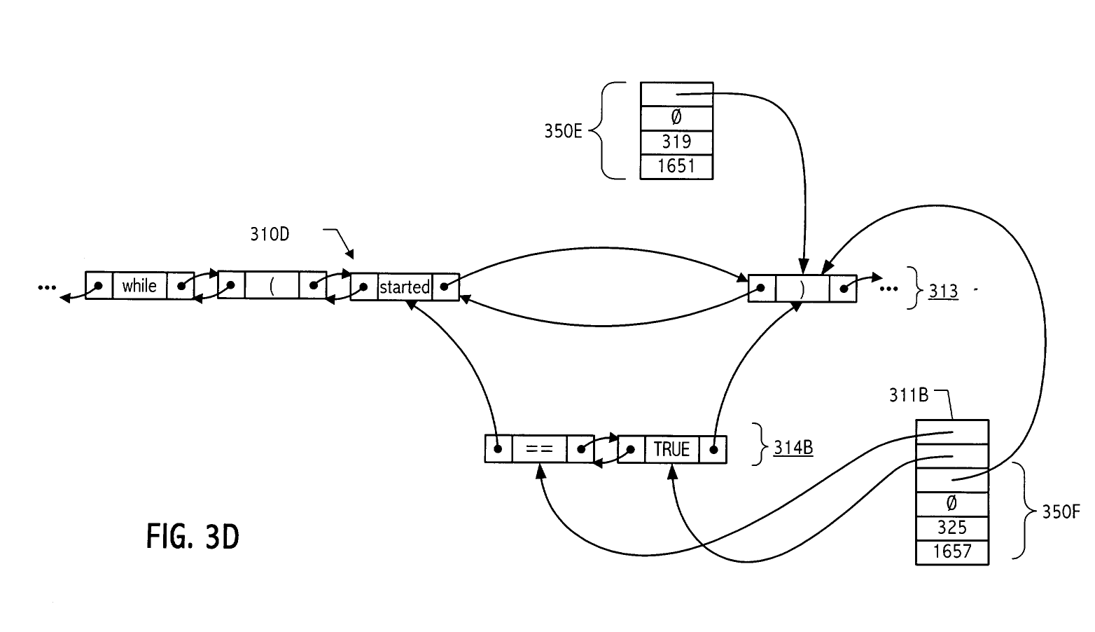

FIGS. 3A, 3B, 3C and 3D illustrate various successive states of a tokenized program representation that is manipulated in response to a remove operation (i.e., an operation that removes one or more tokens) and successive undo and redo operations. As before, FIG. 3A illustrates an initial partial state 310A of a tokenized program representation. For simplicity, only a partial state corresponding to a fragment,

. . . while (started==TRUE) . . . ,

of the total program code is illustrated and the illustrated deletion removes tokens corresponding to potentially superfluous code.

Insertion point 350 identifies a current insertion point in partial state 310A using pointer 351 and a null character offset (from field 352). In particular, the FIG. 2A illustrates current insertion point just before the “)” character of the above-described fragment. Insertion point 350 includes an identification of the current insertion point, in character coordinates, as 325 character positions (see offset field 353) into the tokenized program representation and a representation of total buffer length of 1657 character positions (see field 354). FIG. 3A serves as a base state from which operations to maintain the insertion point and tokenized program representation in the face of token removal operations, as well as undos and redos thereof, will be better understood.

FIG. 3B then illustrates the result of a removal from the tokenized program representation (i.e., from pre-removal state 310A) of two tokens (fragment 314) corresponding to user edits of the program code. In the illustration of FIG. 3B, bi-directional pointers 312 are updated to bridge the excised fragment 314. An undo-redo structure 311 identifies (through respective pointers) opposing end nodes of the excised fragment 314. Note that excised fragment 314 maintains its single direction pointers into respective excision point nodes 321A and 321B to facilitate efficient undo. As before, only the undo-redo structure associated with the illustrated removal is shown in FIG. 3B, although a total representation of program code and undo-redo state may (and typically does) include additional undo-redo objects.

Insertion point 350A includes an identification of the post-removal state of the insertion point, represented in both token coordinates and character coordinates. Based on conventional semantics of a removal operation, the token identification remains the same as before; however, the character coordinates representation has changed in correspondence with attributes of a string representation of excised fragment 314. In addition, total buffer length has been similarly updated.

In the illustrated configuration, undo-redo structure 311 identifies opposing ends of the excised fragment 314. In addition, undo-redo structure 311 includes a stored (or cached) insertion point representation 350B corresponding to the insertion point state and total buffer length state that existed prior to operation of the illustrated removal. Respective token pointer, in-token character offset, character offset and total buffer length fields encode pre-removal states.

Turning to FIG. 3C, we illustrate results of an undo operation that reverses the effect on the tokenized program representation of the previously executed removal operation. In particular, the previously excised token fragment 314A is reintroduced into the doubly-linked list. To effectuate insertion point restoration, the stored (pre-removal) insertion point representation 350B is swapped for that represented as current insertion point state 350A (recall FIG. 3B). The resulting swapped states are illustrated in FIG. 3C. As before, such a swap may be implemented using a swap of pointers (not specifically shown) to respective data structures. Note that undo-redo object 311 A maintains its identification of leading and trailing nodes of the previously excised, now reinstated, fragment 314A. In this way, redo of the previously undone removal of token fragment 314A can be efficiently performed.

Results of a redo are illustrated in FIG. 3D. Reinstatement of the token removal is effectuated by updating bi-directional pointers of the tokenized program representation (see state 310D) to bridge the excised fragment 314B. As before, undo-redo structure 31 1A state (see FIG. 3C) provides the reference chains that allow update of respective pointers of excision point nodes to efficiently redo the previously undone removal. After completion of the redo operation, undo-redo structure 311B continues to identify opposing ends of removed fragment 314B. In this way, a subsequent undo may be efficiently supported. As before, to effectuate insertion point restoration, the stored (post undo or post-removal) insertion point representation 350D is swapped for that represented as current insertion point state 350C (recall FIG. 3C). The resulting swapped states are illustrated in FIG. 3D.

The exemplary code that follows illustrates one suitable functional implementation of the above-described token removal, undo of token removal, and redo of token removal.

// Represents a stream of tokens, represented as a doubly linked
// list with beginning and ending sentinels. The total number of
// characters in the stream is cached at all times.
public class TokenStream {

. . .
// Method for deleting tokens from a doubly linked list
// Precondition:
// - <first> and <last> point to tokens in a doubly linked
// list of Tokens with sentinels
// - The token <first> is either the same as, or prior to
// the token <last> in the list
// - <point> refers to the beginning of the token just
// after <last>
// Postcondition:
// - The tokens beginning with <first> and ending with
// <last> are no longer in the token list, which is
// otherwise unchanged.
// - The cached values in <point> for character
// offset and buffer length are updated.
public UndoRedo delete(Token first, Token last, Point point) {

Token lastBefore = first.previous;
Token firstAfter = last.next;
lastBefore.next = firstAfter;
firstAfter.previous = lastBefore;
UndoRedo undoRedo = new DeleteUndoRedo(first, last,

point);

int deletedLength = computeLength(first,last);
point.streamOffset −= deletedLength;
length −= deletedLength;
return undoRedo;

}
. . .

}

Undo and redo support may be inplemented according to the following exemplary code.

class DeleteUndoRedo implements UndoRedo {

private Token first;
private Token last;
private Token token;
private mt tokenaff set;
private mt streamOff set;
private mt streamLength;
public DeleteUndoRedo (Token first, Token last, Point point) {

this.first = first;
this.last = last;
this.token = point.token;
this.tokenOff set = point.tokenOffset;
this.streamOff set = point.streamOffset;
this.streamLength = point.stream.length;

}
// Exchange state with <point>and the values cached in this
// object
private void swapState (Point point) {

Token tempToken = point.token;
point.token = this.token;
this.token = tempToken;
int tempTokenOff set = point.tokenOffset;
point.tokenOff set = this.tokenOffset;
this.tokenOff set = tempTokenOffset;
int tempStreamOff set = point.streamOff set;
point.streamOffset = this.streamOffset;
this.streamOffset = tempStreamaffset;
int tempStreamLength = point.stream.length;
point.stream.length = this.streamLength;
this.streamLength = tempStreamLength;

}
// Precondition:
// - The state of the token list is just as it was when the
// tokens were originally deleted and this object created.
// - <point> refers to the beginning of the token in the stream
// just after the deleted tokens.
// Postcondition:
// - <point> refers to the same position.
// - The state of token list is just as it was before
// the tokens were originally deleted; the deleted tokens
// are back in the list in their original location.
public void undo (Point point)

Token lastBefore first.previous;
Token firstAfter = last.next;
lastBefore.next first;
firstAfter.previous = last;
swapState (point);

}
// Precondition:
// - The state of the token list is just as it was after Undo
// was invoked: the deleted tokens are in the list in their
// original location.
// - <point> refers to the beginning of the token in the stream
// just after the deleted tokens.
// Postcondition:
// - <point> refers to the same position.
// - The state of the token list is just as it was when the
// tokens were originally deleted and this object created;
// the tokens beginning with <first> and ending with <last>
// are no longer in the token list, which is otherwise
// unchanged.
public void redo (Point point) {

Token lastBefore = first.previous;
Token firstAfter = last.next;
lastBefore.next = firstAfter;
firstAfter.previous = lastBefore;
swapState (point);

}

}

While the previously described insertion and removal operations have been illustrated primarily in the context of a single operation and its associated undo and redo methods, based on the description herein, persons of ordinary skill in the art will recognize that in a typical editing session, or for that matter, in the course of operation another programming tool, multiple insertions and removals of program fragments will occur. Indeed, large number of such insertions and removals will occur and, in general, can be represented as an ordered set of such operations. In some cases, one operation (e.g., a removal) will operate on results of the previous operation (e.g., an insertion). Accordingly, in the general case, it is desirable to represent an ordered set 410 of undo-redo objects (e.g., objects 411A, 411B, etc.) to facilitate the undoing and/or redoing of arbitrary sequences of operations.

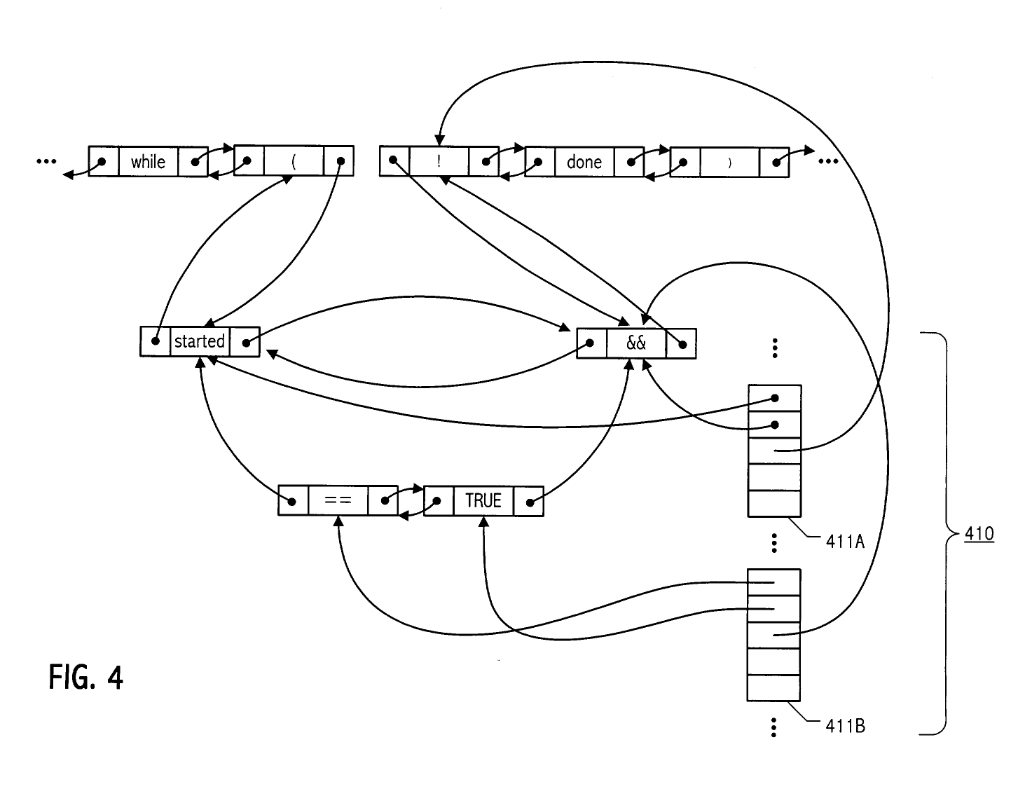

FIG. 4 represents a tokenized program representation that illustrates results of an insertion operation that is followed by a removal operation that targets a portion of the previously inserted code. A partial state 410 of the tokenized program representation and a illustrative state of undo-redo objects are depicted. In particular, ordered set 410 of undo-redo objects includes an undo-redo object 411A that identifies opposing ends of the inserted four node fragment, while undo-redo object 411B identifies an interior portion thereof that has been removed from the state 410 of the tokenized program representation by a subsequent removal operation. Of course, any of a variety of additional edit operations, including intervening edit operations, may correspond to other undo-redo objects (now shown) of the ordered set. In general, the ordered set can be represented in any of a variety of ways. One such representation is as a linked list of such undo-redo objects (links not shown) wherein a current point in the ordered set is maintained and execution of undo operations moves the current point back in the ordered set, while execution of redo operations move the current point forward in the ordered set.

In general, semantics of undo and redo operations are well understood in the art. Of course, a given implementation may seek to limit the amount of storage allocated to undo and redo support and, accordingly, may restrict the growth of the ordered set to a predetermined size. Nonetheless, the techniques described herein may be employed more generally in an unbounded ordered set of undo-redo objects and any particular limitation on sizing of such a structure may be selected based on constraints of a particular implementation or design.

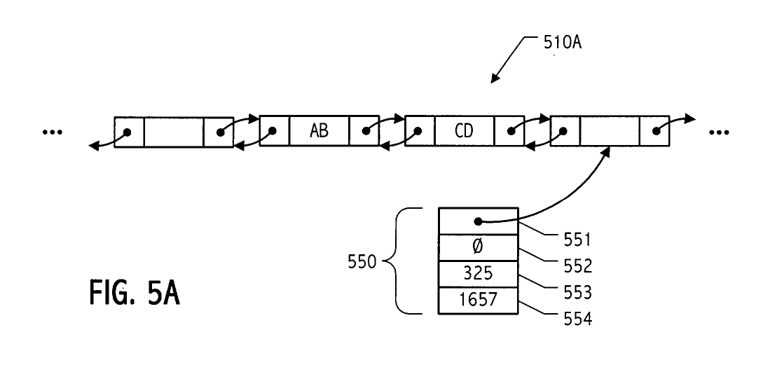

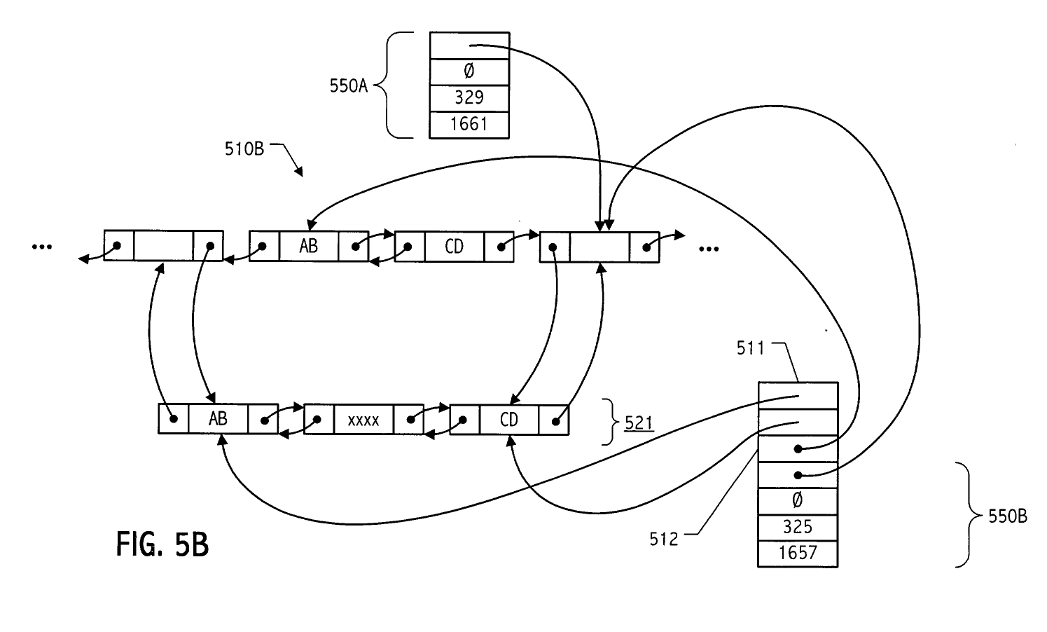

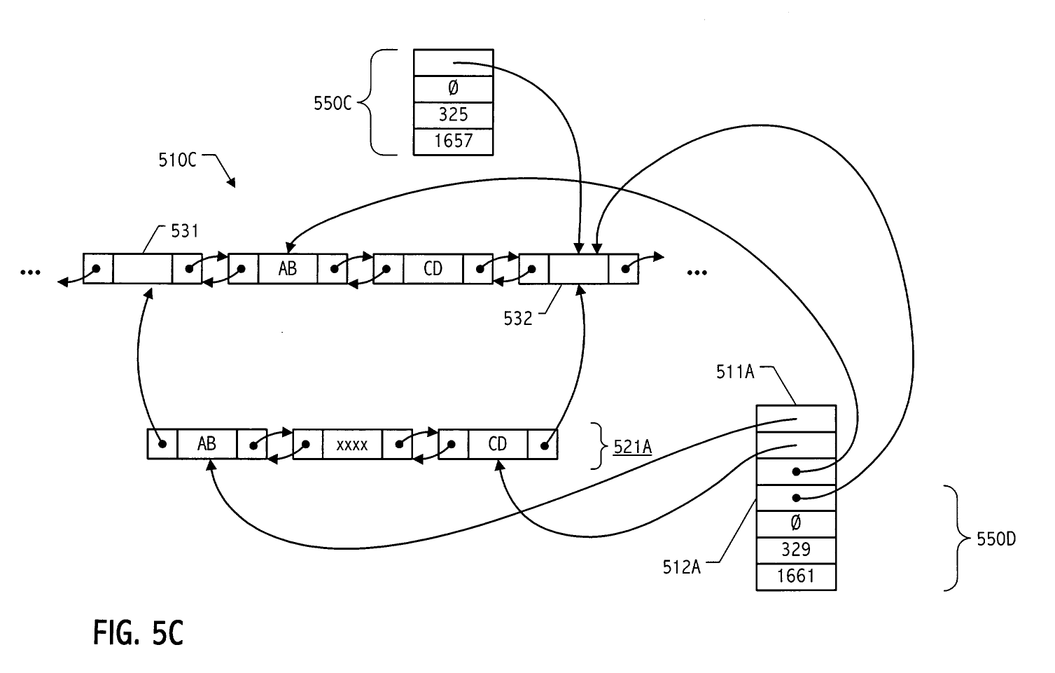

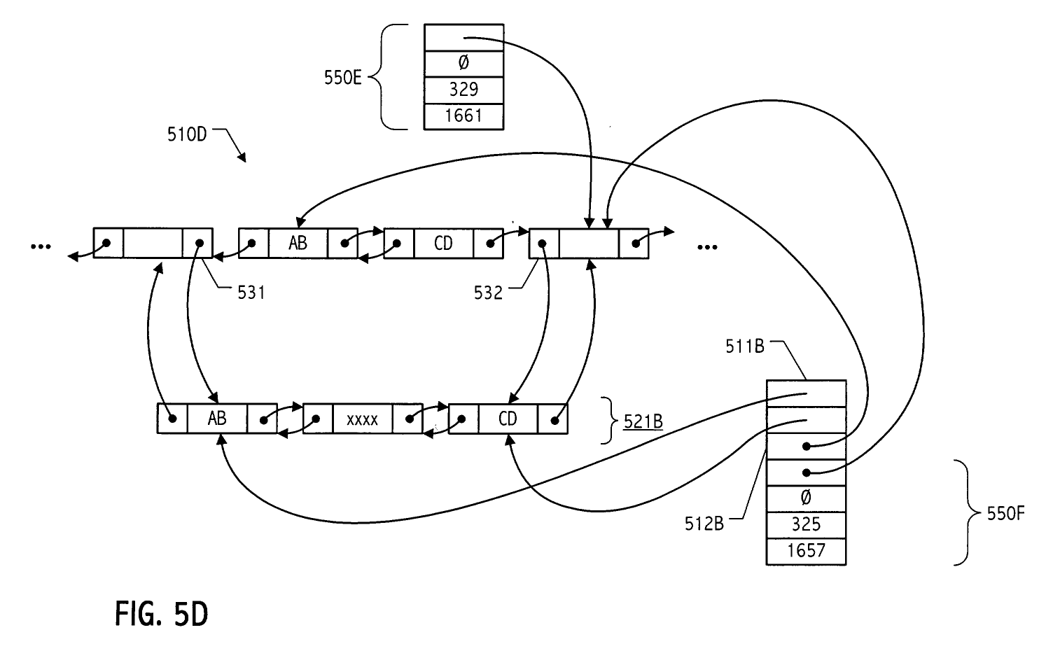

FIGS. 5A, 5B, 5C and 5D illustrate various successive states of a tokenized program representation that is manipulated in response to a replace operation (i.e., an operation that replaces, in the tokenized representation, a first set of one or more tokens with a second set) and successive undo and redo operations. As before, FIG. 5A illustrates an initial partial state 510A of a tokenized program representation and Insertion point 550 identifies a current insertion point using pointer 551 and a null character offset (from field 552). Insertion point 550 includes an identification of the current insertion point, in character coordinates, as 325 character positions (see offset field 553) into the tokenized program representation and a representation of total buffer length of 1657 character positions (see field 554). FIG. 5A serves as a base state from which operations to maintain the insertion point and tokenized program representation in the face of token replace operations, as well as undos and redos thereof, will be better understood.

Turning to FIG. 5B, we illustrate replacement of a two token fragment <AB><CD>with a three token fragment <AB> <xxx> <CD>, illustrated as fragment 521. Operation of such a replace operation is similar to that previously illustrated with respect to an insertion operation except that, rather than operating at a particular insertion point, the splicing in of tokenized program code fragment 521 displaces a fragment of the previous program representation state. To facilitate reinstatement of the displaced fragment, an addition has been made to undo-redo structure 511. In particular, an additional pointer 512 has been added to identify the displaced fragment. In illustration of FIG. 5B, identification is achieved by identifying a lead node of the displaced fragment. More generally, any node of the displaced fragment may suffice, though for simplicity implementations that choose either the leading or trailing node of the displaced fragment are generally preferable. For increased efficiency, undo-redo structure 511 can be modified to include yet another field (not specifically shown) identifying the displaced fragment. In this way, both leading and trailing nodes may be identified, obviating traversal to identify an opposing end. As a result, replacement may be performed at fixed, O(1), overhead rather than with O(N) scaling based on the size of the displaced fragment.

Insertion point 550A includes an identification of the post-replacement state of the insertion point, represented in both token coordinates and character coordinates. Based on conventional semantics of a replacement operation, the token identification remains the same as before; however, the character coordinates representation has changed in correspondence with attributes of a string representation of replacement fragment 521. In addition, total buffer length has been similarly updated.

Undo-redo structure 511 identifies opposing ends of the displaced fragment 521. In addition, undo-redo structure 511 includes a stored (or cached) insertion point representation 550B corresponding to the insertion point state and total buffer length state that existed prior to operation of the illustrated replacement. As before, respective token pointer, in-token character offset, character offset and total buffer length fields encode pre-replacement states.

Referring now to FIG. 5C, results of an undo operation are illustrated. In particular, using the contents of additional field 512A of undo-redo object 511A, an undo operation identifies the previously-displaced fragment and updates the forward pointer of node 531 to partially reinstate the previously displaced fragment. Similarly, execution of the undo operation serves to update the rearward point of node 532 to complete the reinstatement. To effectuate insertion point restoration, the stored (pre-replacement) insertion point representation 550B is swapped for that represented as current insertion point state 550A (recall FIG. 5B). The resulting swapped states are illustrated in FIG. 5C. Note that previously described fields of the undo-redo object provide referencing chains to identify nodes 531 and 532. As before, the previously inserted, but now undone, tokenized program fragment, i.e., fragment 521A, remains identified by pointers represented in undo-redo structure 511A. In this way, efficient redo of the now undone replace operation can be supported.

FIG. 5D illustrates results of a redo operation. Since leading and trailing nodes of tokenized program fragment 521A (recall FIG. 5C) maintain their identification of splice points, namely nodes 531 and 532, redo of the replace operation is straightforward. Identification of the again displaced two-node fragment is maintained using contents of undo-redo structure field 512A (recall FIG. 5C). As before, to effectuate insertion point restoration, the stored (post undo or post- replacement) insertion point representation 550D is swapped for that represented as current insertion point state 550C (recall FIG. 5C). The resulting swapped states are illustrated in FIG. 5D as insertion point representations 550E and 550F.

Although the preceding example has illustrated operation of a replacement operation and corresponding undo and redo operations in the context of a three node for two node replacement, persons of ordinary skill in the art will recognize that the illustrated techniques are more generally applicable to displaced and replacement fragments of any size. Similarly, persons of ordinary skill in the art will recognize that semantics of an insert operation that splits a pre-existing token may be efficiently implemented as a replace operation. Functional code to implement such a replace operation follows:

// Represents a stream of tokens, represented as a doubly linked
// list with beginning and ending sentinels. The total number of
// characters in the stream is cached at all times.
public class TokenStream {

. . .
// Method for replacing tokens in a doubly linked list
// Precondition:
// - <oldFirst> and <oldLast> point to tokens in a doubly
// linked list of Tokens with sentinels
// - the token <oldFirst> is either the same as, or prior to
// the token <oldLast> in the list
// - <point> refers to a position within the range <oldFirst>
// through <oldLast>
// - <newFirst> refers to the first of a doubly linked list of
// at least one Token, which are not in the list referred
// to by <oldFirst> and <oldLast>; <newLast> refers to the
// last of these tokens.
// Postcondition:
// - The tokens beginning with <newFirst> and ending with
// <newLast> are in the token list in place of the tokens
// beginning with <oldFirst> and ending with <oldLast>.
// - The token list is otherwise unchanged
// - <point> refers to the position in the stream in token
// <newPointToken> at character offset <newPointOffset>.
public UndoRedo replace(Token oldFirst, Token oldLast,

Point point, Token newFirst,
Token newLast, Token newPointToken,
int newPointOffset) {

Token lastBefore = oldFirst.previous;
Token firstAfter = oldLast.next;
lastBefore.next = newFirst;
newFirst.previous = lastBefore;
newLast.next = firstAfter;
firstAfter.previous = newLast;
UndoRedo undoRedo = new ReplaceUndoRedo(oldFirst,

newFirst, newLast, point);

int streamOffsetchange = computeDistance(newFirst,

newPointToken, newPointOffset) −
computeDistance(oldFirst,
point.token, point.tokenOffset);

int streamLengthChange = computeLength(newFirst,

newLast) −
computeLength(oldFirst,
oldLast);

point.token = newPointToken;
point.tokenOffset = newPointOffset;
point.streamOffset += streamOffsetChange;
length += streamLengthChange;
return undoRedo;

}
. . .

}

Corresponding undo and redo support may be implemented according to the following exemplary code.

// Represents the ability to undo/redo the replacement of a range
// of tokens from a doubly linked token list with sentinels.
// Maintains enough information to restore previous insertion point
// along with cached values for point character offset and buffer
// size.
class ReplaceUndoRedo implements UndoRedo {

private Token oldFirst;
private Token newFirst;
private Token newLast;
private Token token;
private int tokenOffset;
private int streamOffset;
private int streamLength;
public ReplaceUndoRedo (Token oldFirst, Token newFirst,

Token newLast, Point oldPoint) {

this.oldFirst = oldFirst;
this.newFirst = newFirst;
this.newLast = newLast;
this.token = oldPoint.token;
this.tokenOffset = oldPoint.tokenOffset;
this. streamOffset = oldPoint.streamOffset;
this. streamLength = oldPoint.stream.length;

}
// Exchange state with <point> and the values cached in this
// object
private void swapState(Point point) {

Token tempToken = point.token;
point.token = this.token;
this.token = tempToken;
int tempTokenOffset = point.tokenOffset;
point.tokenOffset = this.tokenOffset;
this.tokenOffset = tempTokenOffset;
int tempStreamOffset = point.streamOffset;
point.streamOffset = this.streamOffset;
this. streamOffset = tempStreamOffset;
int tempStreamLength = point.stream.length;
point.stream.length = this.streamLength;
this.streamLength = tempStreamLength;

}
// Precondition:
// - The state of the token list is just as it was after the
// “old” tokens were originally replaced with “new” tokens
// and this object created.
// - <point> refers to a position in the stream within the
// range of new tokens, including just after.
// Postcondition:
// - The state of token list is just as it was before the
// tokens were originally replaced; the “old” tokens are in
// the list in their original location, and the “new” tokens
// are not in the list.
// - <point> refers to the position it did just before the
// replacement, within the range of the “old” tokens,
// including just after.
public void undo(Point point) {

Token lastBefore = newFirst.previous;
Token firstAfter = newLast.next;
Token oldLast = oldFirst;
while (oldLast.next != firstAfter)

oldLast = oldLast.next;

lastBefore.next = oldFirst;
firstAfter.previous = oldLast;
swapState(point);

}
// Precondition:
// - The state of token list is just as it was before the
// tokens were originally replaced; the “old” tokens are in
// the list in their original location, and the “new” tokens
// are not in the list.
// - <point> refers to the position it did just before the
// replacement, within the range of the “old” tokens,
// including just after.
// Postcondition:
// - The state of the token list is just as it was when the
// tokens were originally replaced and this object created.
// - <point> refers to a position in the stream within the
// range of new tokens, including just after.
public void redo(Point point) {

Token lastBefore = newFirst.previous;
Token firstAfter = newLast.next;
lastBefore.next = newFirst;
firstAfter.previous = newLast;
swapState(point);

}

}

In the preceding exemplary code, the oldFirst field or attribute corresponds to additional field 512, 512A and/or 512B.

Exemplary Editor Implementation

In general, techniques of the present invention may be implemented using a variety of editor implementations. Nonetheless, for purposes of illustration, the description of exemplary editor implementations in U.S. Pat. No. 5,737,608, entitled “PER-KEYSTROKE INCREMENTAL LEXING USING A CONVENTIONAL BATCH LEXER” is incorporated herein by reference. In particular, while the preceding code implements token operations, persons of ordinary skill in the art will recognize that editor and/or programming tools implementations may often include operations that operate at a level of abstraction that corresponds to character manipulations. Such character-oriented manipulations typically affect the state of an underlying token-oriented representation and such state changes can be effectuated using token operations such as the insertion, removal and replacement operations described herein. To generate sequences of token-oriented operations that correspond to character manipulations, incremental lexing techniques described in the '608 patent may be employed in some realizations.

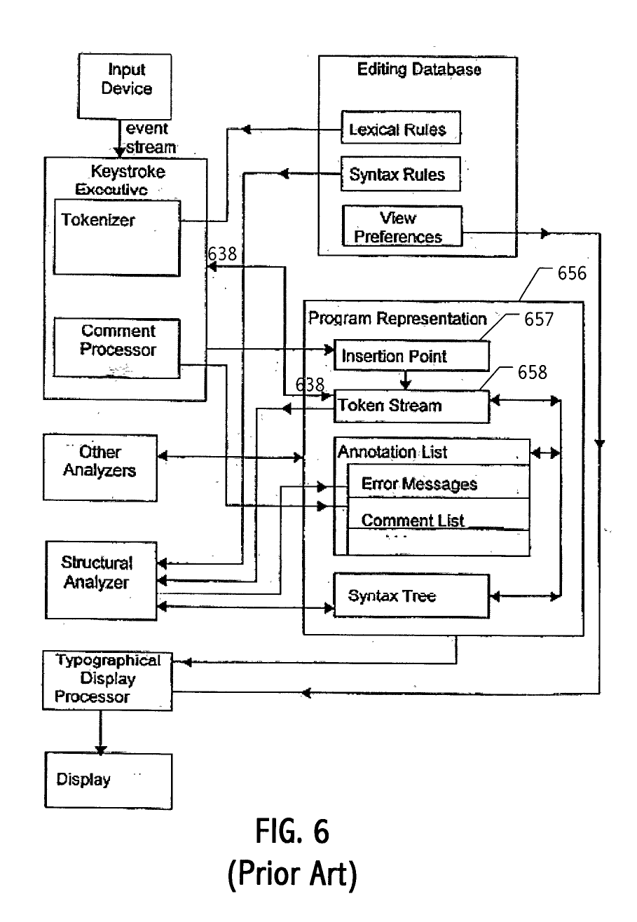

FIG. 6 depicts interactions between various functional components of an exemplary editor implementation patterned on that described in greater detail in the '608 patent. In particular, techniques of the present invention are employed to implement program representation 656, and particularly token stream representation 658 and insertion point representation 657, to support efficient undo and redo operations. By implementing operations 638, including insert, remove and/or replace operations, on token stream representation 658 as described above, undo-redo objects are maintained in correspondence with edit operations efficient undo-redo operations are supported. Based on the description herein, including the above-incorporated description, persons of ordinary skill in the art will appreciate a variety of editor implementations that may benefit from features and techniques of the present invention.

While the invention has been described with reference to various embodiments, it will be understood that these embodiments are illustrative and that the scope of the invention is not limited to them. Many variations, modifications, additions, and improvements are possible. In particular, a wide variety of lexical contexts may be supported. For example, while a lexical context typical of program code has been illustrated, other lexical contexts such as those appropriate to markup languages, comments, even multimedia content may be supported. Similarly, although much of the description has focused on functionality of an editor, the techniques described herein may apply equally to other interactive or even batch oriented tools. While lexical analysis of textual content has been presumed in many illustrations, persons of ordinary skill in the art will recognize that the techniques described herein also apply to structure-oriented editors and to implementations that provide syntactic, as well as lexical, analysis of content.

More generally, plural instances may be provided for components described herein as a single instance. Boundaries between various components, operations and data stores are somewhat arbitrary, and particular operations are illustrated in the context of specific illustrative configurations. Other allocations of functionality are envisioned. Structures and functionality presented as discrete in the exemplary configurations may be implemented as a combined structure or component. These and other variations, modifications, additions, and improvements may fall within the scope of the invention as defined in the claims that follow.

What is claimed is:

1. A method of providing undo operation support in an edit buffer represented as a ordered set of lexical tokens, the method comprising:
maintaining, in correspondence with operations that modify contents of the edit buffer, an ordered set of undo objects that identify respective subsets of the lexical tokens corresponding to content removed by respective ones of the modifying operations; and
maintaining in correspondence with the undo objects, respective encodings of pre-modification states of an insertion point into the edit buffer.

2. The method of claim 1, further comprising:
storing the encodings of pre-modification insertion point states in respective ones of the undo objects.

3. The method of claim 1,
wherein pre-modification insertion point states encode both a token-coordinates representation of insertion point state and a character-coordinates representation of insertion point state.

4. The method of claim 3,
wherein the token-coordinates representation identifies both a token and a character-offset, zero or more, thereinto, which together corresponds to pre-modification insertion point state.

5. The method of claim 3,
wherein the character-coordinates representation at least partially encodes a total character offset into the edit buffer.

6. The method of claim 1, further comprising:
restoring, in correspondence with an undo operation, a corresponding removed one of the lexical token subsets;
restoring, in correspondence with the undo operation, the insertion point using a corresponding one of the pre-modification insertion point state encodings.

7. The method of claim 6,
wherein the restoring includes swapping a then current insertion point state with a pre-modification insertion point state encoding that corresponds to the removed one of the lexical token subsets.

8. The method of claim 6, further comprising:
subsequent to completion of the undo operation and in correspondence with a redo operation, reinstating the undone removal and swapping a then current insertion point state with an insertion point state encoding that corresponds to the reinstated removal.

9. The method of claim 1,
wherein the modifying operations include remove-type operations.

10. The method of claim 1,
wherein the modifying operations include replace-type operations.

11. The method of claim 1,
wherein the modifying operations include insert-type operations that split respective pre-existing ones of the lexical tokens.

12. The method of claim 1, further comprising:
restoring, coincident with an undo directive, the doubly-linked list of lexical tokens to a state that existed prior to prior to execution of a particular remove-type operation at least in part by reintroducing thereinto the sublist identified by a corresponding one of the undo objects; and
maintaining as a redo object, identification of at least the opposing end nodes of the reintroduced sublist.

13. A software engineering tool comprising:
a representation of program code encoded in a computer readable medium as a set of nodes, each node corresponding to a respective token recognized in accordance with an operative set of lexical rules;
functional encodings of edit methods executable to operate on the set of nodes; and
an undo-redo manager that maintains an ordered set of undo-redo objects in correspondence with operation of the edit methods, undo-type ones of the undo-redo objects including respective encodings of insertion point states prior to operation of the respective edit methods.

14. The software engineering tool of claim 13,
wherein redo-type ones of the undo-redo objects include respective encodings of insertion point states after undo of respective edit methods.

15. The software engineering tool of claim 13,
wherein the undo-redo manager further maintains the ordered set of undo-redo objects in correspondence with operation of undo and redo directives, wherein the maintaining includes swapping a pre-directive insertion point state with an insertion point state encoding that corresponds to respectively undone or redone edit operation.

16. The software engineering tool of claim 13, further comprising:
a functional encoding of an undo directive that reverses effects of a previously executed edit operation on state of the list and swaps a then current insertion point state with an insertion point state encoding that corresponds to insertion point state prior to the undone edit operation.

17. The software engineering tool of claim 13,
a functional encoding of a redo directive that reinstates effects of a previously executed edit method on state of the list and swaps a then current insertion point state with an insertion point state encoding that corresponds to insertion point state prior to the undone edit operation.

18. A software engineering tool encoded in one or more computer readable media as instructions executable to represent program code as lexical tokens and to maintain, consistent with an operation that removes one or more lexical tokens from the representation, an undo object that identifies the removed lexical tokens and a pre-modification state of an insertion point.

19. The software engineering tool of claim 18,
wherein the pre-modification state encodes a character coordinates representation of the insertion point.

20. The software engineering tool of claim 18,
wherein the pre-modification state encodes both a token coordinates representation and a character coordinates representation of the insertion point.

21. The software engineering tool of claim 20,
wherein the token coordinates representation identifies both a particular one of the lexical tokens and a character offset thereinto.

22. The software engineering tool of claim 18,
wherein the operation is an remove-type operation and the sublist of lexical tokens corresponds to a substring removed by the remove-type operation.

23. The software engineering tool of claim 18,
wherein the operation is an replace-type operation and the sublist of lexical tokens corresponds to a substring displaced by the remove-type operation.

24. The software engineering tool of claim 18,
wherein the one or more computer readable media are selected from the set of a disk, tape or other magnetic, optical, or electronic storage medium and a network, wireline, wireless or other communications medium.

25. One or more computer readable media encoding a data structure that represents contents of an edit buffer as a sequence of lexical tokens, the encoded data structure comprising:
a doubly linked list of nodes;
token representations each corresponding to at least one respective node of the list, wherein at least some of the token representations have associated substring encodings; and
an ordered representation of undo objects that identify (i) respective sublists of one or more lexical tokens introduced into or removed by a list modifying operation and (ii) a pre-modification state of an insertion point.

26. The encoded data structure of claim 25,
wherein the identification of pre-modification insertion point state allows reversal of introductions and removals, including update of insertion point state, in response to respective undo directives with a computational burden that is independent of size of the edit buffer and independent of size of the introduction or removal.

27. The encoded data structure of claim 25, embodied as a software object that defines at least one of the list modifying operations.

28. The encoded data structure of claim 25,
wherein the one or more computer readable media are selected from the set of a disk, tape or other magnetic, optical, or electronic storage medium and a network, wireline, wireless or other communications medium.

29. An apparatus comprising:
storage for a computer readable encoding of an edit buffer represented as a sequence of lexical tokens; and
means for maintaining an edit-operation-ordered representation of undo objects that each respective sublists of one or more lexical tokens introduced into or removed by a list modifying edit operation and a pre-modification state of an insertion point.

30. The apparatus of claim 29, further comprising:
means for reversing a particular execution of one of the list modifying edit operations using the sublist identification of a corresponding one of the undo objects and using the pre-modification insertion point state.

31. The apparatus of claim 30, further comprising:
means for supporting reinstatement of the reversed edit operation including means for swapping a then current insertion point state with an insertion point state encoding that corresponds to insertion point state prior to the reversed edit operation.
